(19) United States
(12) Patent Application Publication
(10) Pub. No.: US 2021/0090759 A1
(43) Pub. Date: Mar. 25, 2021

(54) FLAT CABLE AND METHOD FOR MANUFACTURING A FLAT CABLE

(71) Applicant: BOZHOU LANTO ELECTRONIC LIMITED, Anhui (CN)

(72) Inventors: Jie ZHANG, Anhui (CN); Tengfei LI, Anhui (CN); Yang LI, Anhui (CN)

(73) Assignee: BOZHOU LANTO ELECTRONIC LIMITED, Anhui (CN)

(21) Appl. No.: 16/954,431

(22) PCT Filed: Oct. 30, 2018
(86) PCT No.: PCT/CN2018/112611

§ 371 Date: Jun. 16, 2020

(30) Foreign Application Priority Data
Dec. 16, 2017 (CN) 201711356575.7

(51) Int. Cl. H01B 7/08; H01B 7/02; H01B 7/18; H01B 11/02; H01B 13/22; H01B 13/06

(52) U.S. Cl. CPC H01B 7/0838; H01B 7/02; H01B 7/0807; H01B 13/06; H01B 11/02; H01B 13/22; H01B 7/18

(57) ABSTRACT

Disclosed are a flat cable and a method for manufacturing the same. The flat cable includes a plurality of pairs of differential signal conductors, a grounding conductor, an insulation sheath, a covering layer, and a metal conductive member. The grounding conductor is disposed between each two adjacent ones of the plurality of pairs of differential signal conductors. The insulation sheath wraps outer sides of the plurality of pairs of differential signal conductors and the grounding conductor. The covering layer covers an outer side of the insulation sheath. An opening is disposed in the insulation sheath, the opening communicates with the grounding conductor, and an area of the opening is greater than an area of the grounding conductor. At least one part of the metal conductive member is received in the opening and is in electrical contact with the grounding conductor.

### CROSS-REFERENCE TO RELATED APPLICATION

This is a National stage application, filed under 37 U.S.C. 371, of International Patent Application NO. PCT/CN2018/112611, filed on Oct. 30, 2018, which is based on and claims priority to a Chinese patent application No. 201711356575.7 filed on Dec. 16, 2017, disclosure of which is incorporated herein by reference in entirety its entirety.

### TECHNICAL FIELD

The present disclosure relates to a flat cable and a method for manufacturing the same.

### BACKGROUND

With the advantages of occupying a small space and being bendable, a flat cable is widely used in various electronic devices to transmit signals. A conventional flat cable includes multiple conductors spaced apart in the left-and-right direction, an insulation sheath wrapping the upper surfaces and the lower surfaces of the conductors, and a conductive shielding layer covering the outer side of the insulation sheath. However, during signal transmission, especially transmission of high-frequency signals, the flat cable is susceptible to interference of external electromagnetic signals. Therefore, the internal structure of the flat cable needs to be improved.

### SUMMARY

The present disclosure provides a flat cable capable of improving the grounding effect and the signal shielding function, and a method for manufacturing the flat cable.

In one embodiment, the present disclosure provides a flat cable. The flat cable includes multiple pairs of differential signal conductors, a grounding conductor, an insulation sheath, a covering layer, and a metal conductive member. The grounding conductor is disposed between each two adjacent ones of the multiple pairs of differential signal conductors. The insulation sheath wraps the outer sides of the multiple pairs of differential signal conductors and the grounding conductor. The covering layer covers the outer side of the insulation sheath. The insulation sheath is provided with an opening. The opening communicates with the grounding conductor, and the area of the opening is greater than the area of the grounding conductor. At least one part of metal conductive member is received in the opening and is in electrical contact with the grounding conductor.

In one embodiment, the present disclosure provides a method for manufacturing a flat cable. The method includes providing multiple pairs of differential signal conductors, a grounding conductor, and an insulation sheath, disposing the grounding conductor between each two adjacent ones of the multiple pairs of differential signal conductors, and causing the insulation sheath to wrap the outer sides of the multiple pairs of differential signal conductors and the grounding conductor; removing a part of the insulation sheath to form an opening, to enable the opening to communicate with the grounding conductor, and make the area of the opening be greater than the area of the grounding conductor; providing a metal conductive member, and receiving at least one part of the metal conductive member in the opening and causing the metal conductive member to be in electrical contact with the grounding conductor; and providing a covering layer, and causing the covering layer to cover the outer sides of the insulation sheath and the metal conductive member.

### BRIEF DESCRIPTION OF DRAWINGS

FIG. 1 is a sectional view of a flat cable according to an embodiment of the present disclosure;

FIG. 2 is another sectional view of the flat cable according to the embodiment of the present disclosure;

FIG. 3 is a flowchart of a method for manufacturing a flat cable according to an embodiment of the present disclosure; and

FIG. 4 is a sectional view of another flat cable according to an embodiment of the present disclosure.

### REFERENCE LIST

11 differential signal conductor

12 grounding conductor

20 insulation sheath

21 opening

30 covering

40 metal conductive member

50 silver paste or solder paste

100 first flat cable

200 second flat cable

### DETAILED DESCRIPTION

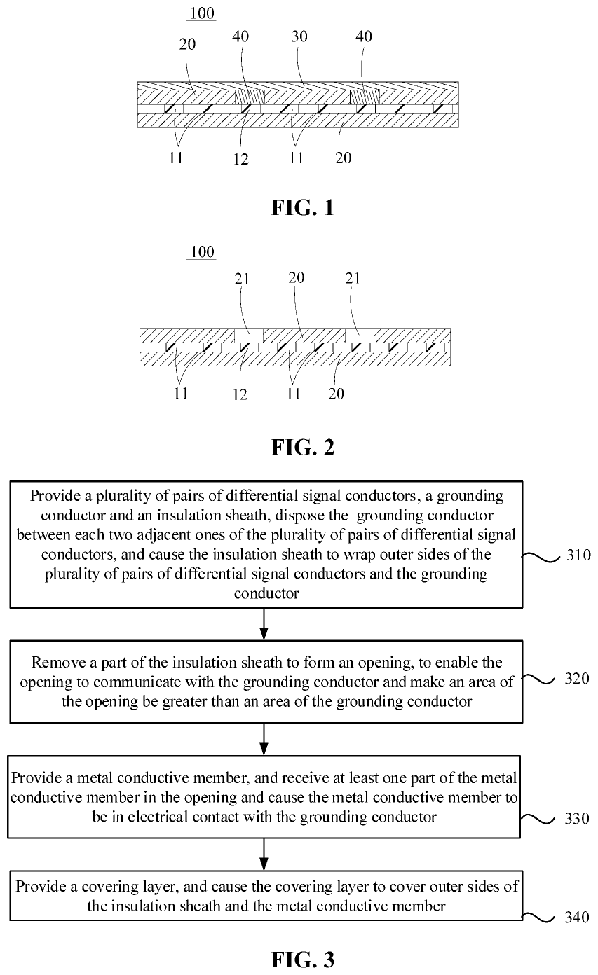

FIG. 1 is sectional view of a flat cable according to one embodiment of the present disclosure. FIG. 2 is a sectional view of another flat cable according to one embodiment of the present disclosure. A conductive shielding layer and sheet metals are not shown in FIG. 2. Referring to FIG. 1 and FIG. 2, a first flat cable 100 according to the present disclosure includes multiple pairs of differential signal conductors 11, a grounding conductor 12 located between each two adjacent pairs of differential signal conductors 11, an insulation sheath 20 wrapping outer sides of the differential signal conductors 11 and the grounding conductors 12, a covering layer 30 covering an outer side of the insulation sheath 20, and metal conductive members 40 in electrical contact with the grounding conductors 12.

In the flat cable according to the present disclosure, multiple grounding conductors are electrically connected to one another in series through the metal conductive members or the covering layer to form a common grounding path so that the grounding effect of the flat cable is improved, the signal shielding function is improved, and the transmission quality of high-frequency signals is improved.

In one embodiment, the metal conductive member 40 may be a sheet metal.

Openings 21 are disposed in the insulation sheath 20 at the positions of the grounding conductors 12. Each opening 21 communicates with a respective one of the grounding conductors 12, and an area of the each opening 21 is greater than an area of the respective one of the grounding conductors 12. That is, the each opening 21 exposes the respective one of the grounding conductors 12.

The covering layer 30 is configured to be a conductive shielding layer or an insulation layer. In the case where the covering layer 30 is the conductive shielding layer, the covering layer 30 is made of copper foil, aluminum foil, conductive cloth, or a composite shielding material in which a conductive material is interposed between layers.

In one embodiment, each metal conductive member 40 is solidified on a respective one of the grounding conductors 12 through welding, fusion, brushing or baking.

In one embodiment, the metal conductive member 40 is an integrated structure or a split structure.

In one embodiment, the covering layer 30 is the insulation layer. In the case where the covering layer 30 is the insulation layer, there are at least two grounding conductors 12, and the at least two grounding conductors 12 are short-circuited through the metal conductive members 40.

In one embodiment, the covering layer 30 is the conductive shielding layer. In the case where the covering layer is the conductive shielding layer, the metal conductive members 40 connect the covering layer 30 and the grounding conductors 12 so that the covering layer 30 is electrically connected to the grounding conductors 12. In this case, there is at least one grounding conductor 12.

In one embodiment, at least one part of each sheet metal is located in a respective one of the openings 21, and welded or fusion-spliced on a respective one of the grounding conductors 12. In the case where the sheet metals are an integrated structure, the multiple grounding conductors 12 are electrically connected to each other in series to form a common grounding path. Such design is beneficial to improving the grounding effect of the first flat cable 100. With such design, the grounding effect is not affected in a case where some individual grounding conductors 12 are not very stable in grounding.

In the case where the covering layer 30 is the conductive shielding layer, the sheet metals may be an integrated structure or a split structure, the outer sides of the sheet metals are in electrical contact with the covering layer 30, and the covering layer 30 electrically connects multiple grounding conductors 12 in series so that a common grounding path is formed, and multiple grounding conductors 12 and the covering layer 30 form a common grounding loop. In this manner, the covering layer 30 can export the noise of the first flat cable 100 by using the grounding so that the signal shielding function is improved, and the transmission quality of high-frequency signals is improved.

In one embodiment, each metal conductive member 40 may be a silver paste or a solder paste. In one embodiment, the present disclosure further provides a method for manufacturing a flat cable. As shown in FIG. 3, the method includes the steps described below.

In step 310, multiple pairs of differential signal conductors, a grounding conductor and an insulation sheath are provided, the grounding conductor is disposed between each two adjacent ones of the multiple pairs of differential signal conductors, and outer sides of the multiple pairs of differential signal conductors and the grounding conductor are wrapped by the insulation sheath.

In step 320, a part of the insulation sheath is removed to form an opening, the opening communicates with the grounding conductor, and an area of the opening is greater than an area of the grounding conductor, that is, the opening exposes the grounding conductor.

In step 330, a metal conductive member is provided, and at least one part of the metal conductive member is received in the opening and is in electrical contact with the grounding conductor.

In step 340, a covering layer is provided, and outer sides of the insulation sheath and the metal conductive members are covered by the covering layer.

After the preceding steps are performed, the manufacturing of the flat cable is completed.

In one embodiment, the metal conductive member 40 may be a sheet metal.

In one embodiment, the step in which the at least one part of the metal conductive member 40 is received in the opening 21 and is in electrical contact with the grounding conductor 12 may include welding or fusion-splicing the at least one part of the metal conductive member 40 on the exposed grounding conductor 12, where the welding manners include tin-added welding or laser welding.

In one embodiment, the metal conductive member 40 is solidified on the grounding conductor 12 through welding, fusion, brushing or baking. In one embodiment, the metal conductive member 40 is an integrated structure or a split structure.

In one embodiment, the covering layer 30 is an insulation layer or a conductive shielding layer. In the case where the covering layer 30 is the insulation layer, there are at least two grounding conductors 12, and the at least two grounding conductors 12 are short-circuited through the metal conductive member 40. In the case where the covering layer 30 is the conductive shielding layer, the covering layer 30 is in electrical contact with the metal conductive member 40, there is at least one grounding conductor 12, and the at least one grounding conductor 12 is electrically connected to the covering layer 30.

In one embodiment, the conductive shielding layer is made of copper foil, aluminum foil, conductive cloth, or a composite shielding material in which a conductive material is interposed between layers.

In one embodiment, the manner of removing a part of the insulation sheath 20 includes laser, punching, or perforating a raw sheath film.

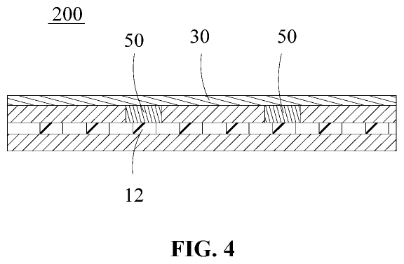

Referring to FIG. 4, FIG. 4 is a sectional view of another flat cable according to one embodiment of the present disclosure. The differences between the first flat cable 100 mentioned in the preceding implementation and a second flat cable 200 are that a silver paste or solder paste 50 is used to replace a sheet metal, the silver paste or solder paste 50 is solidified on a respective grounding conductor 12 through brushing or baking, the covering layer 30 covers the outer side of the silver paste or solder paste 50, and multiple grounding conductors 12 are electrically connected to each other in series through the silver paste or solder paste 50 or the covering layer 30 to form a common grounding path.

To sum up, the metal conductive member 40 according to embodiments of the present disclosure may be a sheet metal or may be a silver paste or solder paste 50, the metal conductive member 40 is in electrical contact with and electrically connected to a respective grounding conductor 12, and multiple grounding conductors 12 are electrically connected to each other in series through the metal conductive members 40 or the covering layer 30 to form a common grounding path. In this manner, the grounding effect of the first flat cable 100 or the second flat cable 200 is improved. In the case where the covering layer 30 is a conductive shielding layer, the covering layer 30 can export the noise of the first flat cable 100 or the second flat cable 200 by using the grounding so that the signal shielding function of the first flat cable 100 or the second flat cable 200 is improved, and the transmission quality of high-frequency signals is improved.

1.-15. (canceled)

16. A flat cable, comprising a plurality of pairs of differential signal conductors, a grounding conductor, an insulation sheath, a covering layer, and a metal conductive member,
wherein the grounding conductor is disposed between each two adjacent ones of the plurality of pairs of differential signal conductors;
the insulation sheath wraps outer sides of the plurality of pairs of differential signal conductors and the grounding conductor;
the covering layer covers an outer side of the insulation sheath; and
the insulation sheath is provided with an opening which communicates with the grounding conductor, an area of the opening is greater than an area of the grounding conductor, and at least one part of the metal conductive member is received in the opening and is in electrical contact with the grounding conductor.

17. The flat cable of claim 16, wherein the metal conductive member is a sheet metal, a silver paste or a solder paste.

18. The flat cable of claim 16, wherein the metal conductive member is solidified on the grounding conductor through welding, fusion, brushing or baking.

19. The flat cable of claim 16, wherein the metal conductive member is an integrated structure or a split structure.

20. The flat cable of claim 16, wherein the covering layer is an insulation layer, there are at least two grounding conductors, and the at least two grounding conductors are short-circuited through the metal conductive member.

21. The flat cable of claim 16, wherein the covering layer is a conductive shielding layer, the covering layer is in electrical contact with the metal conductive member, there is at least one grounding conductor, and the at least one grounding conductor is electrically connected to the covering layer.

22. The flat cable of claim 21, wherein the conductive shielding layer is made of copper foil, aluminum foil, conductive cloth, or a composite shielding material in which a conductive material is interposed between layers.

23. A method for manufacturing a flat cable, comprising:
providing a plurality of pairs of differential signal conductors, a grounding conductor, and an insulation sheath, disposing the grounding conductor between each two adjacent ones of the plurality of pairs of differential signal conductors, and causing the insulation sheath to wrap outer sides of the plurality of pairs of differential signal conductors and the grounding conductor;
removing a part of the insulation sheath to form an opening, to enable the opening to communicate with the grounding conductor and make an area of the opening be greater than an area of the grounding conductor;
providing a metal conductive member, and receiving at least one part of the metal conductive member in the opening and causing the metal conductive member to be in electrical contact with the grounding conductor; and
providing a covering layer, and causing the covering layer to cover outer sides of the insulation sheath and the metal conductive member.

24. The method of claim 23, wherein the metal conductive member is a sheet metal, a silver paste or a solder paste.

25. The method of claim 23, wherein the metal conductive member is solidified on the grounding conductor through welding, fusion, brushing or baking.

26. The method of claim 23, wherein the metal conductive member is an integrated structure or a split structure.

27. The method of claim 23, wherein the covering layer is an insulation layer, there are at least two grounding conductors, and the at least two grounding conductors are short-circuited through the metal conductive member.

28. The method of claim 23, wherein the covering layer is a conductive shielding layer, the covering layer is in electrical contact with the metal conductive member, there is at least one grounding conductor, and the at least one grounding conductor is electrically connected to the covering layer.

29. The method of claim 28, wherein the conductive shielding layer is made of copper foil, aluminum foil, conductive cloth, or a composite shielding material in which a conductive material is interposed between layers.

30. The method of claim 23, wherein a manner of removing the part of the insulation sheath comprises laser, punching, or perforating a raw sheath film.

31. The flat cable of claim 19, wherein the covering layer is an insulation layer, there are at least two grounding conductors, and the at least two grounding conductors are short-circuited through the metal conductive member.

32. The flat cable of claim 19, wherein the covering layer is a conductive shielding layer, the covering layer is in electrical contact with the metal conductive member, there is at least one grounding conductor, and the at least one grounding conductor is electrically connected to the covering layer.

33. The method of claim 24, wherein the metal conductive member is solidified on the grounding conductor through welding, fusion, brushing or baking.

34. The method of claim 26, wherein the covering layer is an insulation layer, there are at least two grounding conductors, and the at least two grounding conductors are short-circuited through the metal conductive member.

35. The method of claim 26, wherein the covering layer is a conductive shielding layer, the covering layer is in electrical contact with the metal conductive member, there is at least one grounding conductor, and the at least one grounding conductor is electrically connected to the covering layer.
